(19) United States
(12) Patent Application Publication
(10) Pub. No.: US 2017/0124787 A1
(43) Pub. Date: May 4, 2017

(54) Wireless Gauge, System, And Method

(71) Applicant: Auto Meter Products, Inc., Sycamore, IL (US)

(72) Inventor: Justin Devlin, Sycamore, IL (US)

(21) Appl. No.: 15/336,389

(22) Filed: Oct. 27, 2016

Related U.S. Application Data
(60) Provisional application No. 62/393,450, filed on Sep. 12, 2016.
(60) Provisional application No. 62/248,547, filed on Oct. 30, 2015.

(51) Int. Cl. G07C 5/08; G07C 5/00

(52) U.S. Cl. CPC G07C 5/0825; G07C 5/008

(57) ABSTRACT

A wireless gauge, system, and method are provided for use in a vehicle. The system includes a transmitting device that transmits information about a vehicle wirelessly to one or more gauges. The system and method may be implemented such that it is unnecessary to cut through or otherwise extend additional wiring through a vehicle's firewall, but instead use an existing vehicle data port. Further, the add-on gauges do not necessarily require additional wiring from the vehicular data port or from the individual vehicle sensors unless desired. A computing device may also be included to configure the add-on gauge, such as by modifying the illumination, alarms, alarm set points, and the like.

### CROSS-REFERENCE TO RELATED APPLICATIONS

This application claims benefit of U.S. Provisional Application No. 62/393,450, filed Sep. 12, 2016, and U.S. Provisional Application No. 62/248,547, filed Oct. 30, 2015.

### FIELD

The present application generally relates to vehicular gauges and, more particularly, to systems including vehicular gauges that receive at least some vehicular information wirelessly.

### BACKGROUND

Vehicles, such as automobiles, motorcycles, boats, airplanes, and the like, generally come equipped from the factory/manufacturer with a specific set of gauges for providing information about the vehicle. In certain instances, the vehicle may include limited customization during manufacture to incorporate additional or different gauges, but oftentimes does not provide sufficient customization for every user. Further, after initial purchase, a user, or subsequent purchaser, may wish to incorporate different gauges into the vehicle to display other vehicular information not otherwise provided for and/or to display vehicular information in a different manner.

For example, a user may wish to know information about the vehicle during use, such as boost pressure, horsepower, oil temperature, and the like. To obtain such information, a user can oftentimes connect a device to the vehicle's data output, such as an on-board diagnostic port. Once connected to the port, a user can view information on a wired display or otherwise wirelessly connect to an auxiliary display, such as a mobile phone.

However, users may prefer to have gauges installed into the vehicle to provide a custom appearance and/or otherwise install the gauges into factory locations. Such an installation oftentimes requires drilling through the vehicle's firewall and then connecting the gauge to the appropriate sensor. The wire then needs to be run through the firewall and behind the dash to the gauge. This can be a complicated process and otherwise may require extensive modification to the vehicle.

Further, even when the wired gauges are installed, users are typically limited to what information may be displayed and/or how the information is displayed. For example, the gauge may include one or more lights, alarms, and the like that can be set prior to installation or by otherwise modifying the physical gauge. This limited customization may be problematic for some users who wish to modify the behavior of the gauge quickly for different operating conditions. For example, a race car user may wish to establish a first set of alarm conditions for a first race and a different set of alarm conditions for a later race.

### SUMMARY

In one form, a wireless gauge, such as for a vehicle, is provided. The wireless gauge may include a wireless connection for receiving data about one or more sensors. The wireless gauge may also include one or more wired connections, such as for providing power to the gauge and/or for connecting multiple gauges together. The additional gauges may also be wireless and/or wired such that the additional gauges can receive data via the wireless gauge or through an alternative source, such as a separate wired connection. One exemplary form of a system includes a transmitting device and an add-on gauge not installed by a vehicle's manufacturer or otherwise is installed by the vehicle's manufacturer and includes wireless communication. The add-on gauge may be an auxiliary gauge, new gauge cluster, duplicate of existing factory gauges, and the like. The transmitting device includes an electrical contact configured to couple to and communicate with a vehicular data port. The transmitting device also includes a wireless output configured to provide at least one of output data from the vehicular data port or analyzed information derived from the output data from the vehicular data port. The add-on gauge is configured to mount to the vehicle, such as in the vehicle's original gauge cluster and/or in an add-on cluster. The add-on gauge includes a wireless input configured to receive data from the wireless output and a display to display data from the wireless output.

The system may also include an access point providing data about one or more sensors wirelessly to one or more gauges.

The system may also include a computing device wirelessly coupled to at least one of the transmitting device and the add-on gauge. The computing device may be wirelessly coupled to the add-on gauge and wirelessly configure the display. The computing device may also display at least one of the output data from the vehicular data port and the analyzed information derived from the output data. Optionally, the add-on gauge includes a wired power input configured to be coupled to the vehicle. The system may also include at least one additional gauge that is wired to the add-on gauge to receive vehicular data therefrom.

In one form, at least one of the transmitting device or the add-on gauge includes a wired connection to a vehicular sensor.

A method of displaying vehicle status information on an add-on gauge not installed by a vehicle's manufacturer is also provided. The method includes wirelessly transmitting, via a transmitting device electrically coupled to a vehicular data port, at least one of output data and analyzed information from the output data from a vehicular data port; wirelessly receiving at the add-on gauge at least one of the output data and the analyzed information from the output data; and displaying information on the add-on gauge about at least one of the output data and the analyzed information from the output data.

The system and method may be implemented such that it is unnecessary to cut through or otherwise extend additional wiring through a vehicle's firewall. Further, the add-on gauges do not necessarily require additional wiring from the vehicular data port or from the individual vehicle sensors unless desired. Instead, the add-on gauges can simply be wired to a power connection, which is typically readily available. Further, the add-on gauges can be configured via a remote computing device, such as a mobile phone. The remote computing device can be used to change the illumination, alarms, alarm set points, audio, and other gauge configuration parameters. Further, the add-on gauge may display information about a first parameter, such as oil pressure, while also being configured to provide an alarm when a set point for another parameter, such as boost pressure, is exceeded. In this regard, a new gauge does not need to be added if all the user desires is an alarm for the parameter and not necessarily a new gauge devoted to the parameter.

These and other aspects may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIGS. 1A-1E depict various forms of gauges as may be used in the method and system;

FIG. 2 is a block diagram representing one form of data communication in a vehicular gauge;

FIG. 3 illustrates one form of a system for providing vehicular status information;

FIG. 4 is a block diagram representing one form of communication with a wireless gauge;

FIG. 5 is a block diagram representing one form of communication with a wireless gauge in combination with extra gauges;

FIG. 6 is a block diagram representing one form of communication with a wireless gauge that is wired to a vehicle sensor;

FIG. 7 is a block diagram representing one form of communication with a wireless gauge and a computing device;

FIG. 8 is a block diagram representing another form of communication with a wireless gauge;

FIG. 9 is a block diagram representing another form of communication; and

FIG. 10 is a depiction of one form of a display for use in a system for providing vehicular status information.

### DETAILED DESCRIPTION

Referring to the figures, a system and method for displaying vehicle status information is provided. The system and method can be utilized in a variety of vehicles including, but not limited to, automobiles, motorcycles, trucks, airplanes, helicopters, boats, ATVs, snowmobiles, farm equipment, and the like. For example, the system and method may be implemented in a racing vehicle to provide additional gauges, to customize the gauge displays, to provide additional alarms, and the like.

In one exemplary form, the system includes a transmitting device and an add-on gauge not installed by a vehicle's manufacturer. In another form, the transmitting device and gauge may be installed by a vehicle's manufacturer, but includes wireless transmission of data. The transmitting device can include an electrical contact and a wireless output. The electrical contact is configured to couple to and communicate with a vehicular data port. The vehicular data port may take a variety of forms including a diagnostic port, such as an on-board diagnostic (OBD, OBDII, and the like) port. In one form, the transmitting device is in the form of a dongle that plugs into an OBDII port. The on-board diagnostic port may be used to provide information from a variety of sensors on the vehicle. Further the system may connect to any vehicular data port available on a vehicle and is not necessarily limited to OBD, OBDII, CAN, or diagnostic options.

The wireless output of the transmitting device may transmit signals via a variety of different wireless protocols. For example, this may be done via Wi-Fi, Bluetooth, infrared, and other wireless methods. The transmitting device may also be configured to transmit and/or receive information over multiple wireless protocols. For example, the transmitting device may communicate via Wi-Fi and Bluetooth. The transmitting device may communicate wirelessly with one or more add-on gauges as well as a remote computing device, as will be discussed below in more detail. In other words, the transmitting device will, at a minimum, transmit, but may also receive information, such that the transmitting device may also be considered a transceiver.

The transmitting device may also include a wired communication connection for communicating with other devices. For example, the transmitting device may include a wired connection for coupling to an additional sensor, such as a sensor that does not provide information through the on-board diagnostic port. The transmitting device may also include a wired connection for coupling to an additional gauge or a configuration device as outlined below in more detail. The transmitting device may also be wired to an add-on gauge and then wirelessly coupled to a remote computing device. The transmitting device may also include an additional wired port, such as a USB port, whereby the transmitting device and/or add-on gauge may be further configured.

In one form, the transmitting device is in the form of an OBD-type dongle. In this form, the transmitting device can take information provided through the OBD port, such as in the form of signals from ECU and other sensors, and then transmit them to the add-on gauge. Additionally, the transmitting device can be removably attached to the vehicle data port such that it can be plugged in and then unplugged when desired and/or moved to a different vehicle as desired.

The add-on gauges typically are not installed by a traditional manufacturer, but may be installed by an owner, user, installer, custom vehicle fabricator, and the like. However, the gauge may also be installed by the vehicle's manufacturer but include wireless transmission of information, as opposed to an entirely wired configuration. The add-on gauge includes a wireless input configured to receive data from the wireless output and a display for displaying data from the wireless output. Just as with the transmitting device, the add-on gauge can use a variety of wireless protocols including, but not limited to Wi-Fi, Bluetooth, infrared, and other wireless methods. Further, the add-on gauges can include multiple forms of wireless communication methods as well as other wired communication ports.

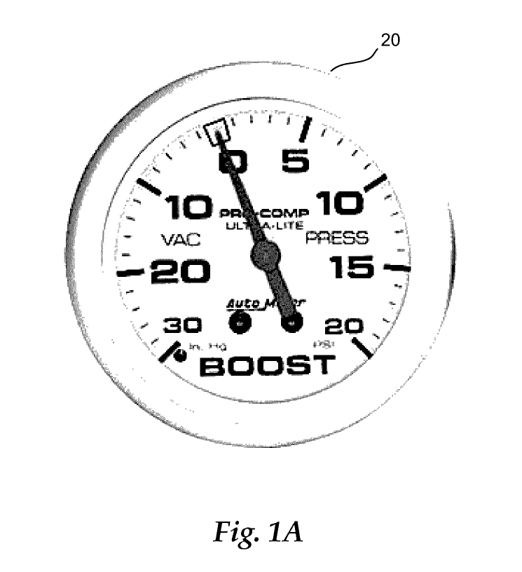

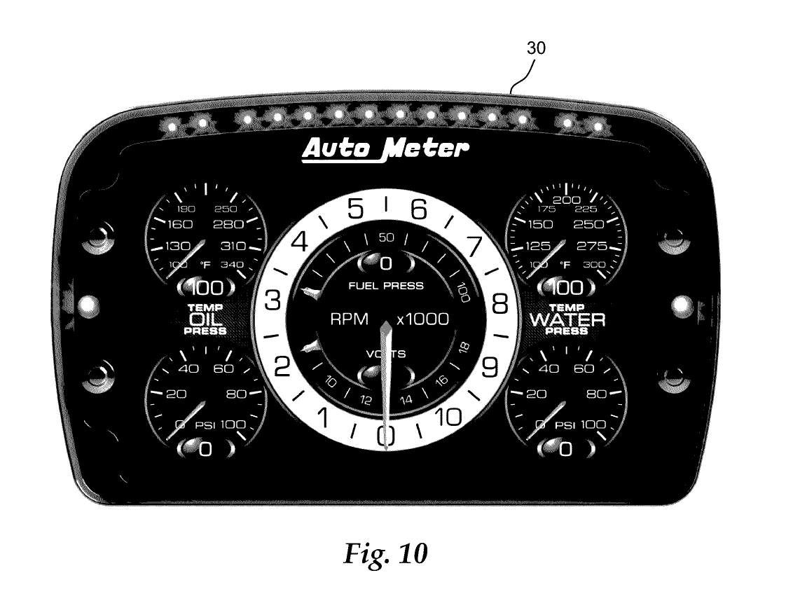

Various forms of add-on gauges are illustrated in FIGS. 1A-1E as reference numbers 20,22,24,26,28. It should be appreciated that the gauges shown in the figures are merely representative of the types of information that can be displayed and/or otherwise provide by the gauges and that other gauges are also contemplated. The add-on gauges can provide the information through an analog display, digital display, audio, tactile form such as vibration, and the like. Further, the add-on gauge can include alarms when certain thresholds are exceeded. One form of a gauge 30 is shown in FIG. 10 where a display such as an LCD display, mobile phone, and the like can be used to display a variety of information. In one form, a user can configure this information to provide desired vehicular parameters, colors for the display, gauge style, and the like.

The add-on gauges can be used to display data from a variety of sensors. For example, the add-on gauges can be used to display boost pressure, vacuum pressure, oil temperature, oil pressure, horsepower, torque, water temperature, tachometer, transmission temperature, ecometer, speedometer, fuel level, voltmeter, various air temperatures, exhaust gas temperatures, fuel pressure, wideband air/fuel ratio, and the like. Other information, such as from one or more other sensors may also be displayed and/or monitored via the gauges and system. The gauges can also be used to display other information that must be computed from the data using formulas, algorithms, and the like. Such computation can be performed by the add-on gauge, transmitting device, or another device, and then displayed on the gauge.

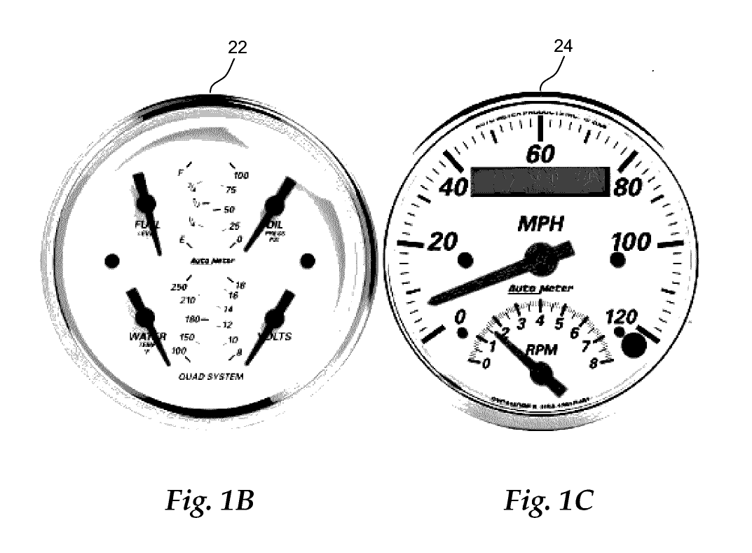

One exemplary form of an add-on gauge 40 is shown in FIG. 2. As seen in this figure, the add-on gauge 40 includes a controller 42, memory 44, lighting 46 for the display, a wireless radio (Wi-Fi) radio 48, and then a movement 50 for moving an analog display marker (Air Core movement). The movement 50 can include any suitable movement. For example, a stepper motor may also be used. When an electronic only display is used, the movement 50 can be omitted. It should be appreciated that, in some forms, the add-on gauge may transmit and receive data between any of the other components in the system.

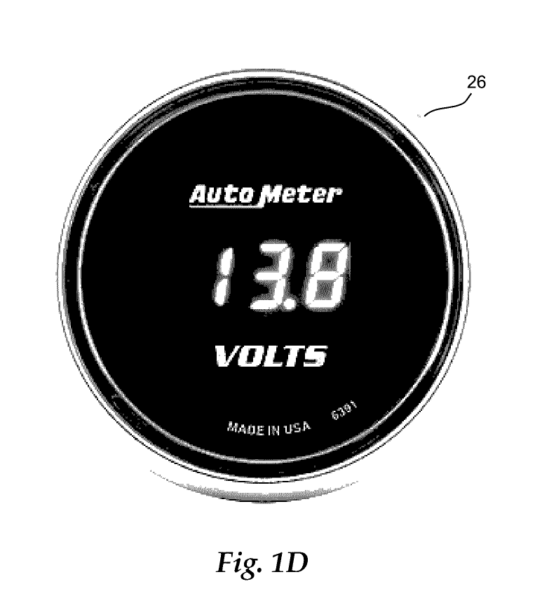

The system can also include a computing device 54 other than a transmitting device 56 and add-on gauge 58. An exemplary system is shown in FIG. 3. The computing device 54 can take a variety of forms, such as a personal computer, mobile phone, tablet, or other device suitable for communication (wired, wireless, or a combination thereof) with one or both of the transmitting device 56 and the add-on gauge 58. For example, in one form, the computing device 54 is a mobile phone that can communicate with both the transmitting device 56 and the add-on gauge 58. In this form, the mobile phone can communicate with the transmitting device 56 to display information in the form of virtual gauges on the mobile phone. The remote computing device may also be used as a data logger, to transmit information to a website or other cloud storage, and the like.

The remote computing device 54, such as a mobile phone, may also communicate with the add-on gauge 58 to configure the add-on gauge and/or transmitting device 56. It should be appreciated that the add-on gauge 58 may also be configured via the transmitting device 56 such that the data provided by the transmitting device 56 is pre-configured for the user's desired display on the add-on gauge. In one form, the configuration settings may be changed at one or more of the transmitting device 56, the add-on gauge 58, or the remote computing device 54. Similarly, the settings may be saved at one or more of the transmitting device 56, the add-on gauge 58, and the remote computing device 54. For example, settings for an add-on gauge 58 may be stored at the transmitting device 56 such that the transmitting device 56 may be removed from a first vehicle and then placed in a second vehicle whereby an analogous add-on gauge 60 may be pre-configured using the settings on the transmitting device 56.

The system can also optionally include an access point for providing wireless and/or wired data between the various components. For example, the access point may be coupled to the transmitting device, such as through a wired and/or Bluetooth connection, and the transmit information wirelessly to an add-on gauge and/or other computing devices. In one form, the access point may function as a Wi-Fi access point which coordinates transmission of data between an OBD and the various gauges. Further, the access point may also have one or more wired ports for receiving information from additional sensors to transmit to the add-on gauge. For example, an OBD may not provide information about a particular sensor and/or the sensor is not provided by the factory such that a user may install the new sensor and have the access point transmit data from the sensor to the add-on gauge.

In one form, the system can also communicate with other computing devices and/or displays. For example, the system may communicate with a data logging device, external test equipment, scan tools, code readers and the like. Further, the system may also communicate with existing displays in a vehicle. For example, the system may communicate with a vehicle's central display, such as typically used for GPS. In this form, data may be displayed in multiple locations, such as the add-on gauge, computing device, and the vehicle's central display. In one form, the system may communicate with a remote computing device, such a mobile phone, and combine vehicle data with sensed data at the mobile phone. For example, the accelerometer in a mobile phone may be combined with data from the transmitting device such that a race user may combine acceleration, braking, and handling information sensed by the mobile phone with parameters such as boost pressure and other vehicular information.

In one form, the add-on gauge may be configured to provide information about a specific vehicle parameter, such as water temperature. However, oftentimes the transmitting device may have access to additional parameters. The add-on gauge may be configured to display information about the first parameter (water temperature) while also being able to provide an alarm for another parameter, such as boost pressure. Therefore, if a user does not want to devote an entire gauge to a specific parameter, the add-on gauge may still be configured to provide an alarm for that extra parameter.

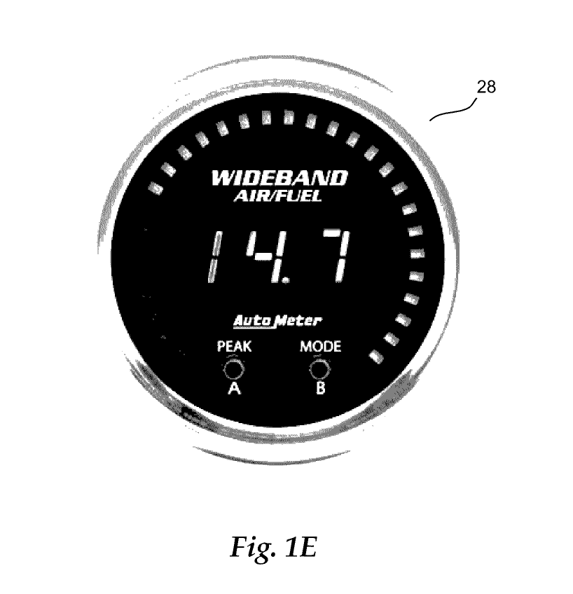

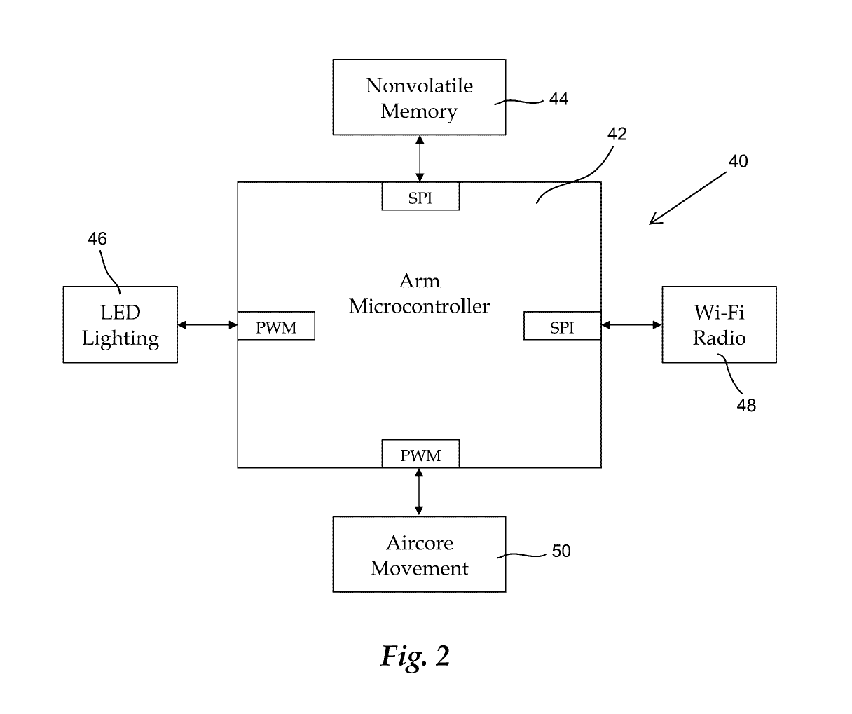

Communication between various devices is shown in the examples of FIGS. 4-8. The transmitting device 100 is shown in the figures as “OBD” while the add-on gauge 102 is illustrated as “Gauge”. As shown in FIG. 4, the transmitting device 100 communicates wirelessly with the add-on gauge 102. FIG. 5 shows a further embodiment whereby the transmitting device 100 communicates wirelessly with a first add-on gauge 102 which then has additional add-on gauges 104,106 wired thereto in a daisy-chain manner. The additional add-on gauges 104,106 may also include wireless communication or may only have wired communication.

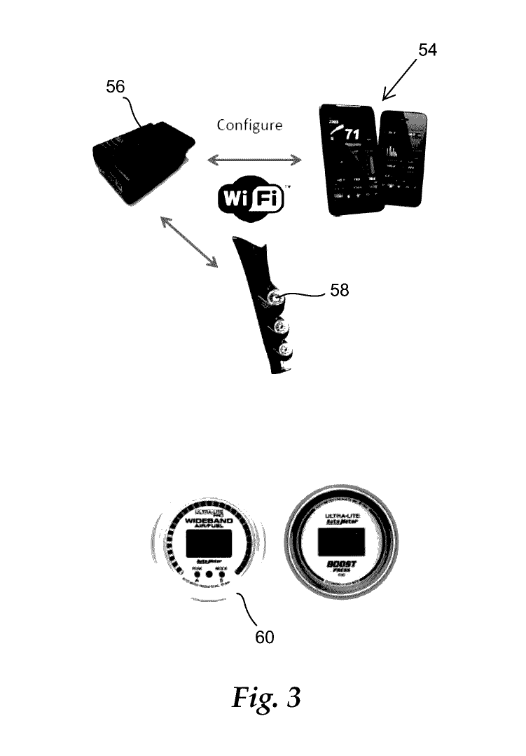

FIG. 6 illustrates a sensor 110 coupled to the transmitting device 100 and a sensor 112 coupled to the add-on gauge 102. The sensors 110,112 may be coupled via wired and/or wireless methods. In one form, the sensor 110 is coupled to the transmitting device 100 via a wired connection whereby the transmitting device 100 may send data about the sensor 110 to the add-on gauge 102. It should be appreciated that a sensor may be coupled to just one of the transmitting device 100 and the add-on gauge 102 or both. Furthermore, the same and/or different sensors may be coupled to the transmitting device 100 and add-on gauge 102.

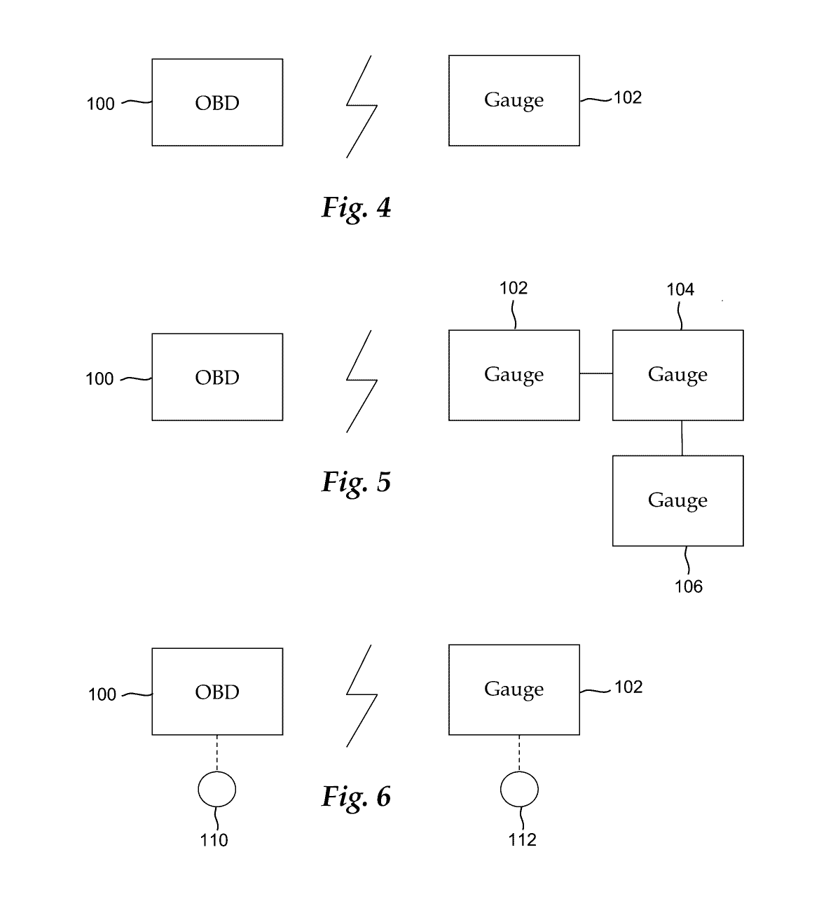

FIG. 7 illustrates a further form whereby the system includes the transmitting device 100, the add-on gauge 102, and the computing device 120. In this form, the transmitting device 100 communicates wirelessly with the add-on gauge 102 and the computing device 120. In an optional form, the computing device 120 may also communicate wirelessly with the add-on gauge 102.

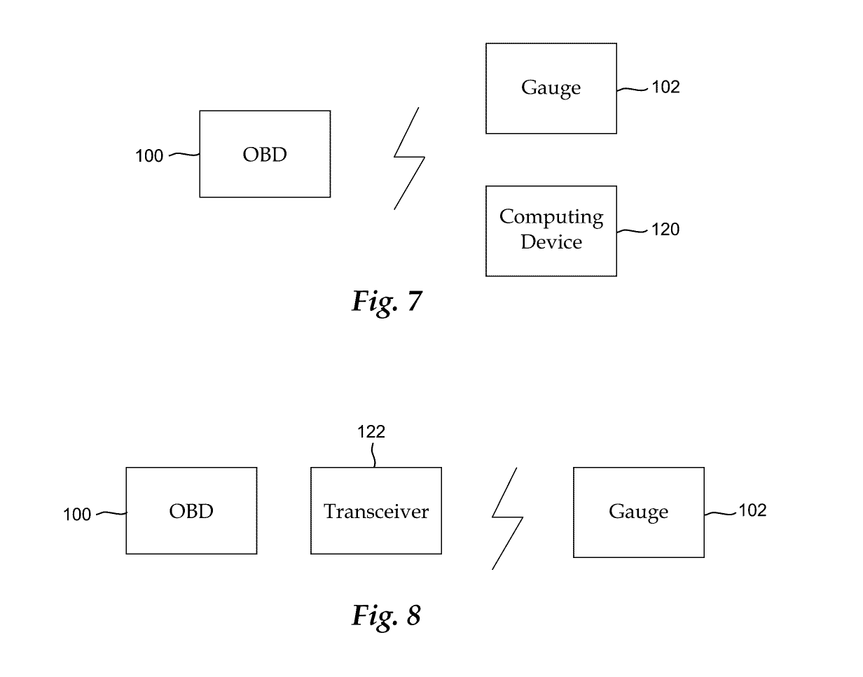

FIG. 8 shows yet another embodiment whereby the system includes an access point 122, such as shown by the “Transceiver”. In this form, the transmitting device 100 is coupled to the access point 122 which then wirelessly transmits data to the add-on gauge 102 and/or other computing devices (not shown).

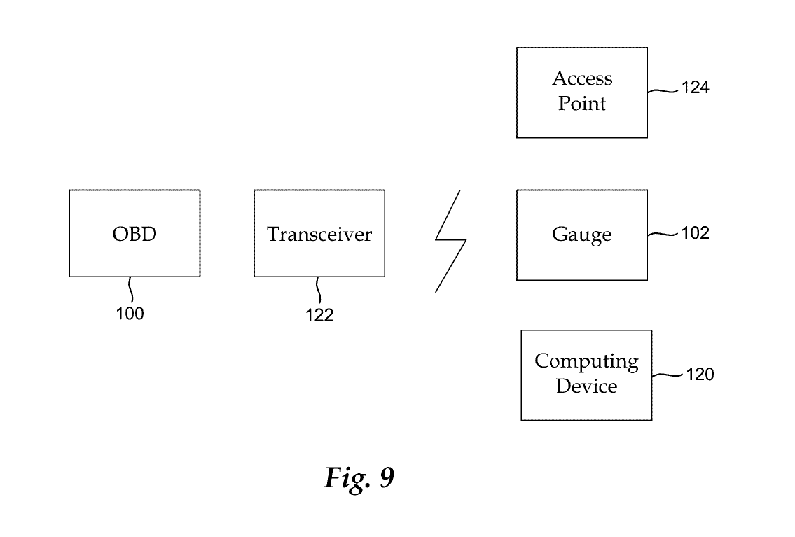

Yet another form is shown in FIG. 9. In this form, an additional access point 124 is included to provide additional methods and types of connectivity, such as to other external sources and computing devices. For example, in one form, the access point 124 can be used in commercial vehicles, agricultural and construction equipment, and the like, whereby other information may be combined such that the access point 124 functions as a host for providing information to add-on gauges and other systems and devices. For example, agricultural equipment may include additional information about the land that is being cultivated such that this information can be aggregated at the access point and then transmitted to other add-on gauges or other remote computing devices.

It should be appreciated that one or more aspects from FIGS. 4-9 may be combined together such that the forms shown in each figure are not exclusive of one another.

In yet another form, the system may communicate with a website or cloud storage location (not shown). In one form, vehicle information from the transmitting device may be sent to a website or cloud storage via the remote computing device, such as a mobile phone. From there, the data may be analyzed and/or stored for later use.

As mentioned previously, a computing device may also be incorporated into the system to provide for further configuration capabilities after the system has been installed in a vehicle. For example, the computing device may be a mobile phone that can display virtual gauges, record data, transfer data to other computing devices and the like. Further, the computing device may also be used to configure how data is displayed at the add-on gauge, such as by changing colors, units for the indicia, and the like. The computing device may also be used to set alarms and/or thresholds such that when the threshold is exceeded, the add-on gauge may flash or display a warning and/or make an audible alarm. The computing device may also be used to quickly switch the add-on gauge between various configurations. For example, the add-on gauge may have a first configuration for street usage and then a second configuration for race usage such that the computing device can cause the add-on gauge to quickly switch between the different configurations.

In yet another form, a computing device, such as a mobile phone, may be used in combination with a transmitting device, such as a dongle plugged into an OBD port. In this form, the mobile phone may be used to determine what add-on gauges may be directly supported by the data provided at the OBD port. Certain data, such as emissions data, is required to be provided by new automobiles. However, other data, such as oil temperature, water temperatures, and the like, may be provided at the manufacturer's discretion. Even further data may be provided in a proprietary code by the manufacturer such that a license may be required to read and/or analyze the data. The transmitting device and mobile phone can be used to determine which data is available at the OBD, which data is available with an added license, and which data is not available unless an extra sensor and/or sender is purchased and installed. In this form, a user may be able to determine which add-on gauges function in the system easily, which gauges will require a license to function, and which gauges will not be supported unless extra sensors and/or senders are installed.

While the add-on gauge has been described in numerous places herein as not having been installed by the vehicle manufacturer, it should be appreciated that, in some instances, the add-on gauge may be installed by the vehicle manufacturer. In such circumstances, the add-on gauge still incorporates wireless communication with one or more of the transmitting device, remote computing device, access point, and combination thereof, as well as any of the other features described herein.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A system for displaying vehicle status information, the system comprising:
a transmitting device including an electrical contact and a wireless output, the electrical contact configured to couple to and communicate with a vehicular data port and the wireless output configured to provide at least one of output data from the vehicular data port or analyzed information derived from the output data from the vehicular data port; and
an add-on gauge configured to mount to a vehicle, the add-on gauge including a wireless input configured to receive data from the wireless output and a display to display data from the wireless output.

2. The system of claim 1 further comprising a computing device wirelessly coupled to at least one of the transmitting device and the add-on gauge.

3. The system of claim 2 wherein the computing device is wirelessly coupled to the add-on gauge and wirelessly configures the display.

4. The system of claim 2 wherein the computing device displays at least one of the output data from the vehicular data port and the analyzed information derived from the output data.

5. The system of claim 1 wherein the add-on gauge includes a wired power input configured to be coupled to the vehicle.

6. The system of claim 1 further comprising at least one additional gauge, the at least one additional gauge being wired to the add-on gauge to receive vehicular data therefrom.

7. The system of claim 1 wherein at least one of the transmitting device and the add-on gauge includes a wired connection configured to couple to a vehicular sensor.

8. The system of claim 1 wherein the add-on gauge includes indicia for a first detected vehicle parameter and an alarm for a second detected vehicle parameter.

9. The system of claim 1 wherein the transmitting device is configured to store and configure configuration settings for the add-on gauge.

10. The system of claim 1 further comprising an access point, the access point configured to transmit data between at least two of the transmitting device, the add-on gauge, and the computing device.

11. A method of displaying vehicle status information on an add-on gauge, the method comprising:
wirelessly transmitting, via a transmitting device electrically coupled to a vehicular data port, at least one of output data or analyzed information from the output data from a vehicular data port;
wirelessly receiving at the add-on gauge at least one of the output data or the analyzed information from the output data; and
displaying information on the add-on gauge about at least one of the output data or the analyzed information from the output data.

12. The method of claim 11 further comprising wirelessly communicating between a computing device and at least one of the transmitting device or the add-on gauge.

13. The method of claim 12 further comprising wirelessly configuring the add-on gauge via the computing device.

14. The method of claim 12 further comprising displaying at least one of the output data from the vehicular data port or the analyzed information derived from the output data on the computing device.

15. The method of claims 11 further comprising transmitting vehicular data from the add-on gauge to an additional add-on gauge via a wired connection.

16. The method of any of claim 11 further comprising displaying information on the add-on gauge from a sensor wired to the add-on gauge.
